(19) United States
(12) Patent Application Publication
(10) Pub. No.: US 2025/0162056 A1
(43) Pub. Date: May 22, 2025

(54) GRINDING-FREE WELDING METHOD FOR FULL-POSITION MULTI-LAYER MULTI-PASS WELDING OF PIPELINE

(71) Applicant: CHENGDU XIONGGU JIASHI ELECTRICAL CO, LTD, Chengdu, Sichuan (CN)

(72) Inventors: Guoqing REN, Chengdu, Sichuan (CN); Minghong LUO, Chengdu, Sichuan (CN); Jiao ZHANG, Chengdu, Sichuan (CN); Xiwang FENG, Chengdu, Sichuan (CN); Hengmin LI, Chengdu, Sichuan (CN); Zengxu JI, Chengdu, Sichuan (CN); Zejun XIAN, Chengdu, Sichuan (CN)

(73) Assignee: CHENGDU XIONGGU JIASHI ELECTRICAL CO, LTD, Chengdu, Sichuan (CN)

(21) Appl. No.: 18/840,940

(22) PCT Filed: Aug. 31, 2022
(86) PCT No.: PCT/CN2022/116127

§ 371 Date: Aug. 23, 2024

(30) Foreign Application Priority Data
Feb. 24, 2022 (CN) 202210176531.0

(51) Int. Cl. B23K 9/167; B23K 9/067; B23K 9/173; B23K 9/235; B23K 101/06

(52) U.S. Cl. CPC B23K 9/167; B23K 9/067; B23K 9/173; B23K 9/235; B23K 2101/06

(57) ABSTRACT

A grinding-free welding method for full-position multi-layer multi-pass welding of a pipeline, includes the following steps: preparing before welding, positioning and aligning, and performing root welding; respectively carrying out clockwise and anticlockwise arc welding on a thermal welding layer, filling layers and cover surface layers, controlling arcing in a segmented mode in a preset lap joint area by means of non-consumable electrode welding and consumable electrode welding, and then carrying out subsequent welding by means of consumable electrode welding. The method controls arcing in a segmented mode by means of non-consumable electrode welding and consumable electrode welding, and carries out subsequent welding by means of consumable electrode welding. The non-consumable electrode welding process is free of welding wire filling and a workpiece arcing area can be heated, then welding wire filling is carried out by means of consumable electrode welding.

The present application claims the priority to Chinese patent application No. 202210176531.0, titled as “ALL-POSITION MULTI-LAYER MULTI-PASS GRINDING-FREE WELDING METHOD FOR PIPELINE”, filed with the Chinese State Intellectual Property Office on Feb. 24, 2022, the entire disclosure of which is incorporated herein by reference.

### FIELD

The present application relates to the field of pipeline welding, and in particular to an all-position multi-layer multi-pass grinding-free welding method for a pipeline.

### BACKGROUND

As shown in FIG. 1, during a construction process of an existing all-position automatic welding site for a pipeline, each welding layer is welded by clockwise welding (CW: 12 o'clock to 3 o'clock to 6 o'clock) and counterclockwise welding (CCW: 12 o'clock to 9 o'clock to 6 o'clock) when hot welding, filling and capping is performed There is an arc starting overlapping zone R at a 12 o'clock position. Specifically, CW arc starting welding is firstly performed, and a CW arc starting point must be manually or automatically ground by means of a grinder before CCW arc starting is performed, otherwise an un-melted defect may be formed by the excessive geometric size of the CW arc starting point when the CCW passes the CW arc starting point. The ground arc starting point of CW can smoothly transition and fill to form a lap joint when the CCW arc passes over the ground CW arc starting point. A previous CCW arc starting point is also ground by means of the grinder before a second CW arc starting is performed, and so on, to finally form a complete weld seam. In addition, oxides on weld bead surfaces at the arc starting positions of the filling layer and a capping layer is cleaned by mechanical grinding, otherwise inclusions may be formed.

The grinding mode in the conventional technology, however, has the following problems:
1, an arc starting zone and an arc starting point of a previous layer need to be ground before the arc starting of each welding layer is performed, and special grinding equipment and personnel need to be equipped, which increases the cost of personnel management and equipment on a construction site;
2, metal dust generated by grinding is a major hidden danger for affecting the occupational health of an on-site worker, which further increases the difficulty of maintenance of other on-site equipment;
3, the grinding process is added, which increases the coordination difficulty between CW torch process and CCW torch process, and seriously reduces the efficiency of the pipeline all-position automatic welding; and
4, at present, in the construction process of the pipeline all-position automatic welding site, the arc starting position is generally ground manually by a constructor, and there is no unified grinding specification (standard) at present. The welding quality of grinding position is greatly affected by a human factor, and the welding quality of the lap joint is unstable.

In addition, in order to solve the problem of the lap joint, there is also relevant technical improvement in the conventional technology. For example, DE102014002213B4 discloses a process and a composite welding torch for metal gas shielded welding, which solves the problems of small penetration and insufficient fusion at the arc starting point of gas shielded welding by first preheating with non-consumable electrode gas shielded welding and then switching to consumable electrode gas shielded welding for arc starting welding in a short time. However, the above invention patent focuses on the design of the composite welding torch, which is suitable for flat surfacing welding, and does not consider the problem that the excess height of the arc starting point of deep groove filling welding needs to be ground, nor does it consider the oxide cleaning of the weld bead surfaces at the arc starting positions of the filling layer and the capping layer. At present, there is no relevant technical improvement to solve the problem of poor fusion of a root face of the arc starting point of the hot welding layer of the composite groove pipeline automatic welding, which can only be solved by grinding.

Therefore, how to effectively solve the problem that the overlapping position needs to be ground during the all-position welding of the pipeline is a technical problem that needs to be solved by those skilled in the art at present.

### SUMMARY

An all-position multi-layer multi-pass grinding-free welding method for a pipeline welding is provided according to the present application, which is configured to improve the welding efficiency and the welding quality of the all-position automatic welding of the pipeline, improve the working environment and reduce the labor intensity.

The all-position multi-layer multi-pass grinding-free welding method for the pipeline includes:
step S1: preparing before welding, positioning and performing a root welding process;
step S2: performing clockwise arc starting welding and counterclockwise arc starting welding on a hot welding layer, controlling arc starting section by section by non-consumable electrode welding and consumable electrode welding in a preset overlapping zone, and then performing subsequent welding by the consumable electrode welding;
step S3: performing clockwise arc starting welding and counterclockwise arc starting welding on a filling layer, controlling the arc starting stage by stage by the non-consumable electrode welding and the consumable electrode welding in the overlapping zone, and then performing subsequent welding by the consumable electrode welding; and
step S4: performing clockwise arc starting welding and counterclockwise arc starting welding on a capping layer, controlling the arc starting stage by stage by the non-consumable electrode welding and the consumable electrode welding in the overlapping zone, and then performing subsequent welding by the consumable electrode welding.

Preferably, the welding grooves are composite grooves.

The method further includes between the step S1 and the step S2:
step S1 A: performing fusion welding without filler wire on the overlapping zone by the non-consumable electrode welding, in which a length of the fusion welding ranges from 20 mm to 40 mm; and
the step S2 includes: performing the arc starting welding in a fusion welding zone obtained in the step S1 A.

Preferably, a length of the overlapping zone ranges from 100 mm to 300 mm; in the clockwise arc starting welding and counterclockwise arc starting welding, a length of a welding overlapping layer of the clockwise welding and the counterclockwise welding is greater than or equal to 30 mm.

Preferably, the controlling arc starting stage by stage by the non-consumable electrode welding and the consumable electrode welding includes:
performing positioning, the arc starting and ignition by an non-consumable electrode welding torch, and controlling the non-consumable electrode torch to move a set distance along a welding direction;
controlling the non-consumable electrode torch to perform arc stopping, and lifting the non-consumable electrode torch; and
controlling a consumable electrode torch to move to a zone welded by the non-consumable electrode torch within a set time to control the arc starting stage by stage after the non-consumable electrode torch performs the arc stopping.

Preferably, the set distance ranges from 2 mm to 10 mm, and the set time ranges from 0.3s to 1.5 s.

Preferably, the controlling the arc starting stage by stage by the non-consumable electrode welding and the consumable electrode welding includes:
during the arc starting, the non-consumable electrode torch is controlled to perform positioning welding and moving welding; in which a positioning welding time corresponding to the non-consumable electrode torch is from 0 to t1, and a moving welding time corresponding to the non-consumable electrode torch is from t1 to t2;
at time instant t2, the non-consumable electrode torch is controlled to perform the arc stopping and stop welding;
during a time period from t2 to t3, the non-consumable electrode torch is controlled to stop welding and to be retracted;
the consumable electrode torch is controlled to reach the fusion welding zone of the non-consumable electrode torch at an initial travelling speed Vt1;
at time instant t3, the consumable electrode torch is controlled to perform the arc starting;
during a time period from t3 to t5, the consumable electrode torch performs a first stage of the arc starting, in which a corresponding welding voltage is changed from a no-load voltage U1 to an initial welding voltage U2, a transition traveling speed is Vt2, and a wire feeding speed is slowly increased from Vf1 to a transition wire feeding speed Vf2, and Vf2−Vf1 is a speed compensation of the first stage;
during a time period from t3 to t4, the consumable electrode torch does not swing;
at time instant t4, the consumable electrode torch starts to swing with an initial swing amplitude A1;
during a time period from t4 to t7, the consumable electrode torch is slowly lowered to swing with a target swing amplitude A2;
during a time period from t5 to t8, the consumable electrode torch performs a second stage of the arc starting, in which the corresponding welding voltage is slowly increased from the initial welding voltage U2 to a target welding voltage U3, and the wire feeding speed is slowly increased from the transition wire feeding speed Vf2 to a target wire feeding speed Vf3;
during a time period from t5 to t6, the traveling speed of the consumable electrode torch is slowly increased from the transition traveling speed is Vt2 to a target traveling speed Vt3; and
at time instant t8, a welding parameter of the consumable electrode torch is a target welding parameter.

Preferably, the non-consumable electrode welding adopts TIG welding, and a welding parameter for the hot welding layer includes:
a welding current I of the TIG welding ranges from 100 A to 300 A

Preferably, the consumable electrode welding adopts MAG welding; a welding parameter for the hot welding layer includes: the initial voltage U2 of the MAG welding ranges from 15V to 26V; the target welding voltage U3 ranges from 19V to 30V; the initial wire feeding speed Vf1 ranges from 180 in/min to 210 in/min; the transition wire feeding speed Vf2 ranges from 220 in/min to 250 in/min; the target wire feeding speed Vf3 ranges from 320 in/min to 450 in/min; the initial traveling speed Vt1 ranges from 100 cm/min to 200 cm/min; the transition traveling speed Vt2 ranges from 30 cm/min to 45 cm/min; the target traveling speed Vt3 ranges from 33 cm/min to 70 cm/min; the initial swing amplitude A1 ranges from 1 mm to 3.5 mm; and the target initial swing amplitude A2 ranges from 1 mm to 3 mm.

Preferably, the non-consumable electrode welding adopts TIG welding, and a welding parameter for the filling layer includes:
a welding current I of the TIG welding ranges from 100 A to 300 A.

Preferably, the consumable electrode welding adopts MAG welding; the initial voltage U2 of the MAG welding ranges from 15V to 26V; the target welding voltage U3 ranges from 19V to 30V; the initial wire feeding speed Vf1 ranges from 180 in/min to 210 in/min; the transition wire feeding speed Vf2 ranges from 220 in/min to 250 in/min; the target wire feeding speed Vf3 ranges from 320 in/min to 450 in/min; the initial traveling speed Vt1 ranges from 100 cm/min to 200 cm/min; the transition traveling speed Vt2 ranges from 40 cm/min to 50 cm/min; the target traveling speed Vt3 ranges from 37 cm/min to 60 cm/min; the initial swing amplitude A1 ranges from 2 mm to 5 mm; and the target initial swing amplitude A2 ranges from 1.5 mm to 5 mm.

Preferably, the non-consumable electrode welding adopts TIG welding, and a welding parameter for the capping layer includes:
a welding current I of the TIG welding ranges from 100 A to 300 A.

Preferably, the consumable electrode welding adopts MAG welding; a welding parameter for the capping layer includes: the initial voltage U2 of the MAG welding ranges from 15V to 26V; the target welding voltage U3 ranges from 19V to 30V; the initial wire feeding speed Vf1 ranges from 180 in/min to 210 in/min; the transition wire feeding speed Vf2 ranges from 220 in/min to 250 in/min; the target wire feeding speed Vf3 ranges from 320 in/min to 400 in/min; the initial traveling speed Vt1 ranges from 100 cm/min to 200 cm/min; the transition traveling speed Vt2 ranges from 30 cm/min to 50 cm/min; the target traveling speed Vt3 ranges from 40 cm/min to 70 cm/min; the initial swing amplitude A1 ranges from 3 mm to 5 mm; and the target initial swing amplitude A2 ranges from 2 mm to 6 mm.

Preferably, the step S3 further includes:
cleaning an oxide on a weld bead surface at an arc starting position by an arc force of the non-consumable electrode welding before the arc starting of the filling layer;
the step S4 further includes:
cleaning the oxide on the weld bead surface at the arc starting position by the arc force of the non-consumable electrode welding before the arc starting of the capping layer.

The all-position multi-layer multi-pass grinding-free welding method for the pipeline is provided according to the present application, which includes the following steps: the step S1: preparing before welding, positioning and performing a root welding process; the step S2: performing clockwise arc starting welding and counterclockwise arc starting welding on the hot welding layer, controlling the arc starting stage by stage by the non-consumable electrode welding and the consumable electrode welding in the preset overlapping zone, and then performing subsequent welding by the consumable electrode welding; the step S3: performing clockwise arc starting welding and counterclockwise arc starting welding on the filling layer, controlling the arc starting stage by stage by the non-consumable electrode welding and the consumable electrode welding in the preset overlapping zone, and then performing subsequent welding by the consumable electrode welding; the step S4: performing clockwise arc starting welding and counterclockwise arc starting welding on the capping layer, controlling the arc starting stage by stage by the non-consumable electrode welding and the consumable electrode welding in the preset overlapping zone, and then performing subsequent welding by the consumable electrode welding. In the all-position multi-layer multi-pass grinding-free welding method for the pipeline, the arc starting is controlled stage by stage by the non-consumable electrode welding and the consumable electrode welding on the hot welding layer, the filling layer and the capping layer respectively, the subsequent welding is performed by the consumable electrode welding, and no welding wire is filled during the non-consumable electrode welding, which can heat the arc starting zone of a workpiece. Due to the high temperature of the arc starting zone of the workpiece when the welding wire is filled by the consumable electrode welding, a molten pool may not be cooled down rapidly, which can be fully spread out. A formed arc starting position is smooth without grinding, which effectively improves the welding efficiency and the welding quality, improves the working environment and reduces the labor intensity.

### BRIEF DESCRIPTION OF THE DRAWINGS

For more clearly illustrating embodiments of the present application or technical solutions in the conventional technology, the drawing referred to for describing the embodiments or the conventional technology will be briefly described hereinafter. Apparently, the drawings in the following description are only some examples of the present application, and for those skilled in the art, other drawings may be obtained based on the provided drawing without any creative efforts.

FIG. 1 is a schematic view showing an all-position welding process of a pipeline in the conventional technology;

FIG. 2 is a flow chart of a specific embodiment of an all-position multi-layer multi-pass grinding-free welding method for a pipeline provided according to the present application;

FIG. 3 is a control time sequence diagram of controlling arc starting stage by stage of the welding method provided according to the present application; and

FIG. 4 is a schematic view of a weld bead in the welding method provided according to the present application.

The reference numerals are as follows:
100, pipeline; R, overlapping zone.

### DETAILED DESCRIPTION OF THE EMBODIMENTS

An all-position multi-layer multi-pass grinding-free welding method for a pipeline is provided according to the present application, which is configured to improve the welding efficiency and the welding quality of the pipeline all-position automatic welding, improve the working environment and reduce the labor intensity.

In order for a better understanding of the solutions according to the present application by those skilled in the art, the solutions are illustrated hereinafter in further detail and in conjunction with the drawings and embodiments.

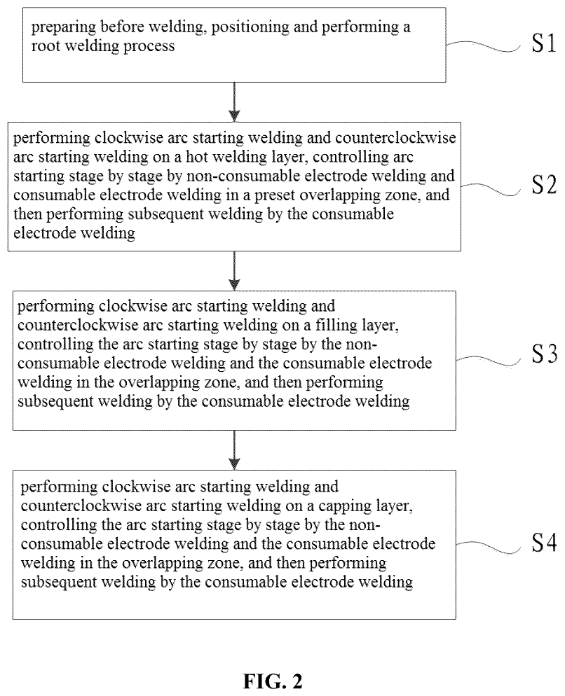

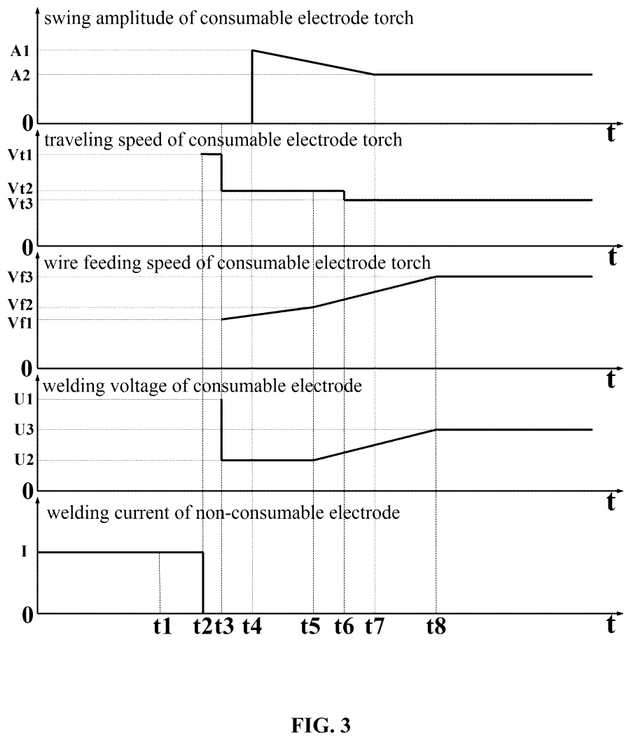

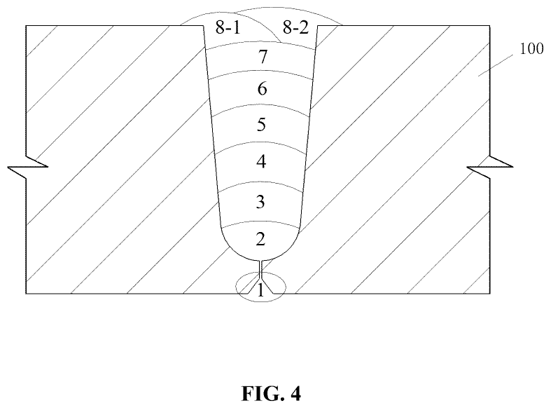

Referring to FIGS. 2 to 4, FIG. 2 is a flow chart of a specific embodiment of an all-position multi-layer multi-pass grinding-free welding method for a pipeline provided according to the present application; FIG. 3 is a control time sequence diagram of controlling arc starting stage by stage of the welding method provided according to the present application; and FIG. 4 is a schematic view of a weld bead in the welding method provided according to the present application.

In this embodiment, the all-position multi-layer multi-pass welding grinding-free welding method for the pipeline includes the following steps:
step S1: preparing before welding, positioning and performing a root welding process;
step S2: performing clockwise arc starting welding and counterclockwise arc starting welding on a hot welding layer, controlling arc starting stage by stage by non-consumable electrode welding and consumable electrode welding in a preset overlapping zone R, and then performing subsequent welding by the consumable electrode welding;
in which an arc starting height is a vertical distance from a tungsten electrode to an arc starting point, which ranges from 2 mm to 3 mm;
step S3: performing clockwise arc starting welding and counterclockwise arc starting welding on a filling layer, controlling the arc starting stage by stage by the non-consumable electrode welding and the consumable electrode welding in the overlapping zone R, and then performing subsequent welding by the consumable electrode welding; and
step S4: performing clockwise arc starting welding and counterclockwise arc starting welding on a capping layer, controlling the arc starting stage by stage by the non-consumable electrode welding and the consumable electrode welding in the overlapping zone R, and then performing subsequent welding by the consumable electrode welding.

Specifically, in the step S1, the preparing before welding includes: selecting an automatic external welding machine, an automatic internal welding machine and a pipeline 100, defining a U-shaped composite groove or a V-shaped groove at a position to be welded of the pipeline 100, and butting and positioning the positions to be welded, that is, butting two sections of the pipeline 100, and positioning a welding torch and the grooves. As shown in FIG. 4, the U-shaped composite groove is used in this embodiment, and a width of an upper groove is 8 mm. different welding layers may be divided according to a welding layer planning: a root welding layer (zone 1), a hot welding layer (zone 2), a filling layer (zone 3, 4, 5, 6, 7) and a capping layer (zone 8-1 and zone 8-2); the internal welding machine is adjusted to butt and position the positions to be welded of the pipeline 100, then the weld bead is preheated, the welding of the root welding layer is completed by the all-position automatic internal welding machine, and then the internal welding machine is removed.

In an embodiment, the welding grooves are composite grooves; and the method further includes between the step S1 and the step S2:
step S1 A: performing fusion welding without filler wire on the overlapping zone R by an automatic argon arc welding machine, in which a length of the fusion welding ranges from 20 mm to 40 mm; and
the step S2 includes: performing arc starting welding in a fusion welding zone obtained in the step S1 A.

Specifically, for the composite groove, the automatic internal welding machine may be used to complete the root welding, and then the step S1 A is performed; for other form of groove, such as the single V-shaped groove, the automatic external welding machine may be used to complete the root welding, and then the step S2 is directly performed.

Preferably, a welding current of the automatic argon arc welding machine ranges from 180 A to 280 A.

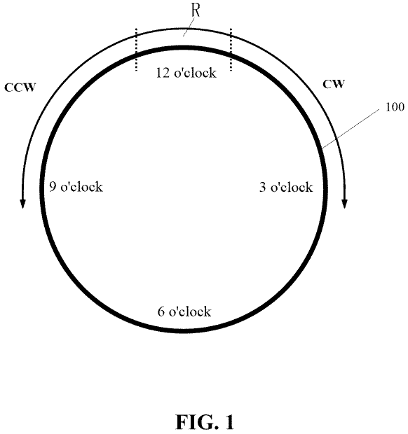

Preferably, a length of the overlapping zone R ranges from 100 mm to 300 mm. As shown in FIG. 1, the overlapping zone R may be a zone ranging from 50m to 150 mm on two sides of a 12 o'clock position respectively, which forms the arc starting overlapping zone. Alternatively, the overlapping zone R may be set according to actual needs without taking the 12 o'clock position as the midpoint. In the clockwise arc starting welding and counterclockwise arc starting welding, a length of a welding overlapping layer between the clockwise welding and the counterclockwise welding is greater than or equal to 30 mm.

Specifically, in an embodiment, in the step S2, a root face of the groove in a zone with a total length of 30 mm on two sides of the 12 o'clock position which may be with a length of 15 mm on each side of the 12 o'clock position, or may be set according to actual needs without taking the 12 o'clock position as the midpoint, can be performed fusion welding without filler wire by automatic argon arc welding, and a preset welding current is 210 A, so that the root face can be fused with the root welding layer. Furthermore, the arc starting is performed above the clockwise welding layer, the length of the welding overlapping layer between the clockwise welding and the counterclockwise welding is greater than or equal to 30 mm. Preferably, the length of the welding overlapping layer is 40 mm. In the step S3 and the step S4, the welding process corresponding to the filling layer and the capping layer is the same with the process and the arc starting control method of the hot welding layer, and the parameters are changed.

Furthermore, an integrated composite welding torch or a split welding torch may be used in the combined welding of the non-consumable electrode welding and the consumable electrode welding. A non-consumable electrode welding torch can move up and down in a height direction driven by a driving device; the arc starting height is the vertical distance from the tungsten electrode to the arc starting point, which preferably ranges from 2 mm to 3 mm.

Based on the above embodiments, the controlling the arc starting stage by stage by the non-consumable electrode welding and the consumable electrode welding includes:
performing positioning, the arc starting and ignition by the non-consumable electrode welding torch, and controlling the non-consumable electrode torch to move a set distance along a welding direction;
controlling the non-consumable electrode torch to perform arc stopping, and lifting the non-consumable electrode torch; and
controlling a consumable electrode torch to move a zone welded by the non-consumable electrode torch within a set time to control the arc starting stage by stage after the non-consumable electrode torch performs the arc stopping.

Based on the above embodiments, the set distance ranges from 2 mm to 10 mm, and the set time ranges from 0.3 s to 1.5 s.

Based on the above embodiments, the controlling the arc starting stage by stage by the non-consumable electrode welding and the consumable electrode welding includes:
during the arc starting, controlling the non-consumable electrode torch to perform positioning welding and moving welding; in which a positioning welding time corresponding to the non-consumable electrode torch is from 0 to t1, and a moving welding time corresponding to the non-consumable electrode torch is from t1 to t2;
at time instant t2, the non-consumable electrode torch is controlled to perform the arc stopping and stop welding;
during a time period from t2 to t3, the non-consumable electrode torch is controlled to stop welding and to be retracted;
the consumable electrode torch is controlled to reach the fusion welding zone of the non-consumable electrode torch at an initial travelling speed Vt1;
at time instant t3, the consumable electrode torch is controlled to perform the arc staring;
during a time period from t3 to t5, the consumable electrode torch performs a first stage of the arc starting, in which a corresponding welding voltage is changed from a no-load voltage U1 to an initial welding voltage U2, a transition traveling speed is Vt2, and a wire feeding speed is slowly increased from Vf1 to a transition wire feeding speed Vf2, and Vf2-Vf1 is a speed compensation of the first stage;
during a time period from t3 to t4, the consumable electrode torch does not swing;
at time instant t4, the consumable electrode torch starts to swing with an initial swing amplitude A1;
during a time period from t4 to t7, the consumable electrode torch is slowly lowered to swing with a target swing amplitude A2;
during a time period from t5 to t8, the consumable electrode torch performs a second stage of the arc starting, in which the corresponding welding voltage is slowly increased from the initial welding voltage U2 to a target welding voltage U3, and the wire feeding speed is slowly increased from the transition wire feeding speed Vf2 to a target wire feeding speed Vf3;
during a time period from t5 to t6, the traveling speed of the consumable electrode torch is slowly increased from the transition traveling speed is Vt2 to a target traveling speed Vt3; and
at time instant t8, a welding parameter of the consumable electrode torch is a target welding parameter.

Based on the above embodiments, the step S3 includes:
cleaning an oxide on a weld bead surface at an arc starting position by an arc force of the non-consumable electrode welding before the arc starting of the filling layer;
the step S4 further includes:
cleaning the oxide on the weld bead surface at the arc starting position by an arc force of the non-consumable electrode welding before the arc starting of the capping layer.

That is, the oxide on the weld bead surface at the arc starting position can be cleaned by the arc force of the non-consumable electrode welding before the arc starting of the filling layer and the capping layer, which effectively avoids the oxide inclusion that may be formed at the arc starting position of subsequent consumable electrode welding; it should be noted here that the above steps are preferably performed when there is oxide in the weld bead, and may not be performed when the weld bead surface is clean and does not need to be cleaned.

Based on the above embodiments, the controlling the arc starting stage by stage by the non-consumable electrode welding and the consumable electrode welding includes:
during the arc starting, controlling the non-consumable electrode torch to perform positioning welding and moving welding; in which a positioning welding time period corresponding to the non-consumable electrode torch is from 0 to t1, and a moving welding time period corresponding to the non-consumable electrode torch is from t1 to t2;
at time instant t2, the non-consumable electrode torch is controlled to perform the arc stopping and stop welding;
during a time period from t2 to t3, the non-consumable electrode torch is controlled to stop welding and to be retracted;
the consumable electrode torch is controlled to reach the fusion welding zone of the non-consumable electrode torch at an initial travelling speed Vt1;
at time instant t3, the consumable electrode torch is controlled to perform the arc starting;
during a time period from t3 to t5, the consumable electrode torch performs a first stage of the arc starting, in which a corresponding welding voltage is changed from a no-load voltage U1 to an initial welding voltage U2, a transition traveling speed is Vt2, and a wire feeding speed is slowly increased from Vf1 to a transition wire feeding speed Vf2, and Vf2−Vf1 is a speed compensation of the first stage;
during a time period from t3 to t4, the consumable electrode torch does not swing; at time instant t4, the consumable electrode torch starts to swing with an initial swing amplitude A1;
during a time period from t4 to t7, the consumable electrode torch is slowly lowered to swing with a target swing amplitude A2;
during a time period from t5 to t8, the consumable electrode torch performs a second stage of the arc starting, in which the corresponding welding voltage is slowly increased from the initial welding voltage U2 to a target welding voltage U3, and the wire feeding speed is slowly increased from the transition wire feeding speed Vf2 to a target wire feeding speed Vf3;
during a time period from t5 to t6, the traveling speed of the consumable electrode torch is slowly increased the transition traveling speed is Vt2 to a target traveling speed Vt3; and
at time instant t8, a welding parameter of the consumable electrode torch is a target welding parameter.

In a specific embodiment, the non-consumable electrode welding adopts TIG welding, and by the consumable electrode welding adopts MAG welding; as shown in FIG. 1, a TIG welding torch first performs positioning welding and moving consumable welding during the arc staring, the positioning welding time period corresponding to the TIG welding torch is (0, t1), the moving welding time period corresponding to the TIG welding torch is (t1, t2); at time instant t2, the TIG welding torch performs the arc stopping and stops welding; during the time period of (t2, t3), the TIG welding torch stops welding and is retracted, while a MAG welding torch is driven by a traveling device to reach a zone welded by the TIG welding torch at the initial travelling speed Vt1; at time instant t3, the MAG welding torch performs the arc starting; the time period (t3, t5) is the first stage of the arc starting of the MAG welding torch, in which the corresponding welding voltage is U2, the travelling speed is Vt2, the wire feeding speed is slowly increased from Vf1 to Vf2, and Vf2−Vf1 is a speed compensation of the first stage; (t3, t4) is the swing delay, that is, the MAG welding torch does not swing during this time period, and starts to swing with the initial swing amplitude A1 at time instant t4, and is slowly lowered to normal swing during the time period (t4, t7); the time period (t5, t8) is the second stage of the arc starting of the MAG welding torch, in which the corresponding welding voltage is slowly increased from U2 to U3 during this period, and the wire feeding speed is slowly increased from Vf2 to Vf3; the time period (t5, t6) is the delay time of the slow rise of the traveling speed, that is, the MAG welding torch still travels at the speed of Vt2 when the second stage of the arc starting of the MAG welding torch starts, and is changed to travel at the travelling speed Vt3 of the second stage at time instant t6, and the target welding parameter is entered after the second stage of the arc starting of the MAG welding torch is completed, that is, after time instant t8.

Based on the above embodiments, t1=2s±0.5s, t2=2.8 s±0.5s, t3=3.1s±0.5s, t4=3.5s±0.5s, t5=4.6s±0.5s, t6=5.1s±0.5s, t7=5.5s±0.5s, and t8=6.6s±0.5s.

Preferably, the corresponding time parameters in the time sequence diagram shown in FIG. 1 are preferably as shown in Table 1.

TABLE 1

| (0, t1) | (t1, t2) | (t2, t3) | (t3, t4) | (t4, t7) | (t3, t5) | (t5, t6) | (t5, t8) |
|---|---|---|---|---|---|---|---|
| 2 s | 0.8 s | 0.3 s | 0.4 s | 2 s | 1.5 s | 0.5 s | 2 s |

It should be noted that, the above time parameters can be adjusted as required when different weld beads are designed, which is not limited to the method given in this embodiment.

Based on the above embodiments, the non-consumable electrode welding adopts TIG welding, and a welding parameter for the hot welding layer includes:
a welding current I of the TIG welding ranges from 200 A to 280 A.

Based on the above embodiments, the consumable electrode welding adopts MAG welding; a welding parameter for the hot welding layer includes: the initial voltage U2 of the MAG welding ranges from 19V to 22V; the target welding voltage U3 ranges from 23V to 26V; the initial wire feeding speed Vf1 ranges from 185 in/min to 200 in/min; the transition wire feeding speed Vf2 ranges from 225 in/min to 240 in/min; the target wire feeding speed Vf3 ranges from 375 in/min to 390 in/min; the initial traveling speed Vt1 ranges from 115 cm/min to 130 cm/min; the transition traveling speed Vt2 ranges from 36 cm/min to 41 cm/min; the target traveling speed Vt3 ranges from 33 cm/min to 70 cm/min; the initial swing amplitude A1 ranges from 1.7 mm to 2.5 mm; and the target initial swing amplitude A2 ranges from 1.2 mm to 2.0 mm.

Based on the above embodiments, the non-consumable electrode welding adopts TIG welding, and a welding parameter for the filling layer includes:
a welding current I of the TIG welding ranges from 200 A to 280 A.

Based on the above embodiments, MAG welding the consumable electrode welding adopts MAG welding; a welding parameter for the filling layer includes: the initial voltage U2 of the MAG welding ranges from 19V to 22V; the target welding voltage U3 ranges from 23V to 26V; the initial wire feeding speed Vf1 ranges from 170 in/min to 220 in/min; the transition wire feeding speed Vf2 ranges from 210 in/min to 260 in/min; the target wire feeding speed Vf3 ranges from 390 in/min to 420 in/min; the initial traveling speed Vt1 ranges from 115 cm/min to 130 cm/min; the transition traveling speed Vt2 ranges from 40 cm/min to 48 cm/min; the target traveling speed Vt3 ranges from 37 cm/min to 45 cm/min; the initial swing amplitude A1 ranges from 2 mm to 4.5 mm; and the target initial swing amplitude A2 ranges from 1.5 mm to 4 mm.

Based on the above embodiments, TIG welding the non-consumable electrode welding adopts TIG welding, and a welding parameter for the capping layer includes:
a welding current I of the TIG welding ranges from 200 A to 280 A.

Based on the above embodiments, the consumable electrode welding adopts MAG welding; a welding parameter for the capping layer includes: the initial voltage U2 of the MAG welding ranges from 19V to 22V; the target welding voltage U3 ranges from 23V to 26V; the initial wire feeding speed Vf1 ranges from 140 in/min to 190 in/min; the transition wire feeding speed Vf2 ranges from 180 in/min to 230 in/min; the target wire feeding speed Vf3 ranges from 210 in/min to 260 in/min; the initial traveling speed Vt1 ranges from 115 cm/min to 130 cm/min; the transition traveling speed Vt2 ranges from 36 cm/min to 41 cm/min; the target traveling speed Vt3 ranges from 33 cm/min to 60 cm/min; the initial swing amplitude A1 ranges from 3.2 mm to 4.0 mm; and the target initial swing amplitude A2 ranges from 2.7 mm to 3.5 mm.

Since the workpiece is in a low-temperature state during the conventional welding process, high current and high wire feeding speed are required for the arc starting if the consumable electrode welding is directly used. However, the molten pool at the arc starting position may rapidly be cooled down and solidified when the low-temperature workpiece is encountered with the high current and high wire feeding speed, a weld seam may be formed with a high residual height, and the previous arc starting point must be smoothed and ground before the next welding. In the all-position multi-layer multi-pass grinding-free welding method for the pipeline, the root face with a specific length on two sides of the 12 o'clock position is performed fusion welding without filler wire by the non-consumable electrode welding before hot welding, which solves the fusion problem of the root face at the arc starting point of the hot welding layer. The arc starting is controlled stage by stage by the non-consumable electrode welding and the consumable electrode welding, the non-consumable electrode welding is performed firstly, and no welding wire is filled in this process, which can heat the starting position of the workpiece. When the welding wire is filled by the consumable electrode welding, slowly rising wire feeding speed and voltage are used in conjunction with the workpiece with a high-temperature, the molten pool will not be cooled down quickly, the filler metal can be fully spread out, the formed arc starting position is smoother, and the oxide on the weld bead surface at the arc starting position can be cleaned by the arc force of the non-consumable electrode welding, which can effectively solve the problems that incomplete fusion of the arc starting point of the hot welding layer and the excessive height and inclusion of the arc starting point during the filling process in the conventional technology must be solved by means of mechanical grinding, so as to improve the welding quality and welding efficiency, improve the working environment and save labor.

It should be noted that, in this embodiment, the non-consumable electrode welding is preferably the TIG welding, and the consumable electrode welding is preferably the MAG welding; however, in addition to perform fusion welding on the root face, heat the arc starting point and clean the oxide by the heating method of the non-consumable electrode welding, other heating methods that can realize controlling the arc starting stage by stage without grinding, such as laser welding, electron beam welding, plasma arc welding, flame heating, induction heating, etc., are also available, which are not limited to the methods given in this embodiment; Similarly, the consumable electrode welding may be Melt Insert-Gas Arc welding, Melt Active Gas Arc welding or Mixed Gas Arc welding, or other forms of the consumable electrode heating method can be selected. Further, the workpiece to be welded may be a pipe or other annular or spherical workpiece; The material to be welded may be carbon steel, stainless steel, aluminum alloy or other metal materials, which can be selected according to the actual use needs, and is not further limited here.

The all-position multi-layer multi-pass grinding-free welding method for the pipeline provided according to the present application has been described in detail above. Specific examples are used in this specification to illustrate the principle and implementation of the present application. The description of the above embodiments is only used to facilitate understanding of the method and core concept of the present application. It should be noted that, for those skilled in the art, many modifications and improvements may be made to the present disclosure without departing from the principle of the present application, and these modifications and improvements are also deemed to fall into the protection scope of the present application defined by the claims.

What is claimed is:

1. An all-position multi-layer multi-pass grinding-free welding method for a pipeline, comprising:
step S1: preparing before welding, positioning and performing a root welding process;
step S2: performing clockwise arc starting welding and counterclockwise arc starting welding on a hot welding layer, controlling arc starting stage by stage by non-consumable electrode welding and consumable electrode welding in a preset overlapping zone, and then performing subsequent welding by the consumable electrode welding;
step S3: performing clockwise arc starting welding and counterclockwise arc starting welding on a filling layer, controlling the arc starting stage by stage by the non-consumable electrode welding and the consumable electrode welding in the overlapping zone, and then performing subsequent welding by the consumable electrode welding; and
step S4: performing clockwise arc starting welding and counterclockwise arc starting welding on a capping layer, controlling the arc starting stage by stage by the non-consumable electrode welding and the consumable electrode welding in the overlapping zone, and then performing subsequent welding by the consumable electrode welding.

2. The all-position multi-layer multi-pass grinding-free welding method for the pipeline according to claim 1, wherein the welding grooves are composite grooves;
the method further includes between the step S1 and the step S2:
step S1 A: performing fusion welding without filler wire on the overlapping zone by the non-consumable electrode welding, wherein a length of the fusion welding ranges from 20 mm to 40 mm; and
the step S2 comprises: performing arc starting welding in a fusion welding zone obtained in the step S1 A.

3. The all-position multi-layer multi-pass grinding-free welding method for the pipeline according to claim 1, wherein a length of the overlapping zone ranges from 100 mm to 300 mm; in the clockwise arc starting welding and counterclockwise arc starting welding, a length of a welding overlapping layer between the clockwise welding and the counterclockwise welding is greater than or equal to 30 mm.

4. The all-position multi-layer multi-pass grinding-free welding method for the pipeline according to any one of claims 1 to 3 claim 1, wherein the controlling arc starting stage by stage by the non-consumable electrode welding and the consumable electrode welding comprises:
performing positioning, the arc starting and ignition by a non-consumable electrode welding torch, and controlling the non-consumable electrode torch to move a set distance along a welding direction;
controlling the non-consumable electrode torch to perform arc stopping, and lifting the non-consumable electrode torch; and
controlling a consumable electrode torch to move a zone welded by the non-consumable electrode torch within a set time to control the arc starting stage by stage after the non-consumable electrode torch performs the arc stopping.

5. The all-position multi-layer multi-pass grinding-free welding method for the pipeline according to claim 4, wherein the set distance ranges from 2 mm to 10 mm, and the set time ranges from 0.3 s to 1.5 s.

6. The all-position multi-layer multi-pass grinding-free welding method for the pipeline according to claim 4, wherein the controlling the arc starting stage by stage by the non-consumable electrode welding and the consumable electrode welding comprises:
during the arc starting, the non-consumable electrode torch is controlled to perform positioning welding and moving welding; wherein a positioning welding time period corresponding to the non-consumable electrode torch is from 0 to t1, and a moving welding time period corresponding to the non-consumable electrode torch is from t1 to t2;
at time instant t2, the non-consumable electrode torch is controlled to perform the arc stopping and stop welding;
during a time period from t2 to t3, the non-consumable electrode torch is controlled to stop welding and to be retracted;
the consumable electrode torch is controlled to reach the fusion welding zone of the non-consumable electrode torch at an initial travelling speed Vt1;
at time instant t3, the consumable electrode torch is controlled to perform the arc starting;
during a time period from t3 to t5, the consumable electrode torch performs a first stage of the arc starting, wherein a corresponding welding voltage is changed from a no-load voltage U1 to an initial welding voltage U2, a transition traveling speed is Vt2, and a wire feeding speed is slowly increased from Vf1 to a transition wire feeding speed Vf2, and Vf2−Vf1 is a speed compensation of the first stage;
during a time period from t3 to t4, the consumable electrode torch does not swing;
at time instant t4, the consumable electrode torch starts to swing with an initial swing amplitude A1;
during a time period from t4 to t7, the consumable electrode torch is slowly lowered to swing with a target swing amplitude A2;
during a time period from t5 to t8, the consumable electrode torch performs a second stage of the arc starting, wherein the corresponding welding voltage is slowly increased from the initial welding voltage U2 to a target welding voltage U3, and the wire feeding speed is slowly increased from the transition wire feeding speed Vf2 to a target wire feeding speed Vf3;
during a time period from t5 to t6, the traveling speed of the consumable electrode torch is slowly increased from the transition traveling speed is Vt2 to a target traveling speed Vt3; and
at time instant t8, a welding parameter of the consumable electrode torch is a target welding parameter.

7. The all-position multi-layer multi-pass grinding-free welding method for the pipeline according to claim 6, wherein the non-consumable electrode welding adopts TIG welding, and a welding parameter for the hot welding layer comprises:
a welding current I of the TIG welding ranges from 100 A to 300 A.

8. The all-position multi-layer multi-pass grinding-free welding method for the pipeline according to claim 7, wherein the consumable electrode welding adopts MAG welding;
a welding parameter for the hot welding layer comprises:
the initial voltage U2 of the MAG welding ranges from 15V to 26V; the target welding voltage U3 ranges from 19V to 30V; the initial wire feeding speed Vf1 ranges from 180 in/min to 210 in/min; the transition wire feeding speed Vf2 ranges from 220 in/min to 250 in/min; the target wire feeding speed Vf3 ranges from 320 in/min to 450 in/min; the initial traveling speed Vt1 ranges from 100 cm/min to 200 cm/min; the transition traveling speed Vt2 ranges from 30 cm/min to 45 cm/min; the target traveling speed Vt3 ranges from 33 cm/min to 70 cm/min; the initial swing amplitude A1 ranges from 1 mm to 3.5 mm; and the target initial swing amplitude A2 ranges from 1 mm to 3 mm.

9. The all-position multi-layer multi-pass grinding-free welding method for the pipeline according to claim 6, wherein the non-consumable electrode welding adopts TIG welding, and a welding parameter for the filling layer comprises:
a welding current I of the TIG welding ranges from 100 A to 300 A.

10. The all-position multi-layer multi-pass grinding-free welding method for the pipeline according to claim 9, wherein the consumable electrode welding adopts MAG welding;
a welding parameter for the filling layer comprises:
the initial voltage U2 of the MAG welding ranges from 15V to 26V; the target welding voltage U3 ranges from 19V to 30V; the initial wire feeding speed Vf1 ranges from 180 in/min to 210 in/min; the transition wire feeding speed Vf2 ranges from 220 in/min to 250 in/min; the target wire feeding speed Vf3 ranges from 320 in/min to 450 in/min; the initial traveling speed Vt1 ranges from 100 cm/min to 200 cm/min; the transition traveling speed Vt2 ranges from 40 cm/min to 50 cm/min; the target traveling speed Vt3 ranges from 37 cm/min to 60 cm/min; the initial swing amplitude A1 ranges from 2 mm to 5 mm; and the target initial swing amplitude A2 ranges from 1.5 mm to 5 mm.

11. The all-position multi-layer multi-pass grinding-free welding method for the pipeline according to claim 6, wherein the non-consumable electrode welding adopts TIG welding, and a welding parameter for the capping layer comprises:
a welding current I of the TIG welding ranges from 100 A to 300 A.

12. The all-position multi-layer multi-pass grinding-free welding method for the pipeline according to claim 11, wherein the consumable electrode welding adopts MAG welding;
a welding parameter for the capping layer comprises:
the initial voltage U2 of the MAG welding ranges from 15V to 26V; the target welding voltage U3 ranges from 19V to 30V; the initial wire feeding speed Vf1 ranges from 180 in/min to 210 in/min; the transition wire feeding speed Vf2 ranges from 220 in/min to 250 in/min; the target wire feeding speed Vf3 ranges from 320 in/min to 400 in/min; the initial traveling speed Vt1 ranges from 100 cm/min to 200 cm/min; the transition traveling speed Vt2 ranges from 30 cm/min to 50 cm/min; the target traveling speed Vt3 ranges from 40 cm/min to 70 cm/min; the initial swing amplitude A1 ranges from 3 mm to 5 mm; and the target initial swing amplitude A2 ranges from 2 mm to 6 mm.

13. The all-position multi-layer multi-pass grinding-free welding method for the pipeline according to claim 1, wherein the step S3 further comprises:
cleaning an oxide on a weld bead surface at an arc starting position by an arc force of the non-consumable electrode welding before the arc starting of the filling layer;
the step S4 further comprises:
cleaning the oxide on the weld bead surface at the arc starting position by the arc force of the non-consumable electrode welding before the arc starting of the capping layer.

14. The all-position multi-layer multi-pass grinding-free welding method for the pipeline according to claim 2, wherein the controlling arc starting stage by stage by the non-consumable electrode welding and the consumable electrode welding comprises:
performing positioning, the arc starting and ignition by a non-consumable electrode welding torch, and controlling the non-consumable electrode torch to move a set distance along a welding direction;
controlling the non-consumable electrode torch to perform arc stopping, and lifting the non-consumable electrode torch; and
controlling a consumable electrode torch to move a zone welded by the non-consumable electrode torch within a set time to control the arc starting stage by stage after the non-consumable electrode torch performs the arc stopping.

15. The all-position multi-layer multi-pass grinding-free welding method for the pipeline according to claim 3, wherein the controlling arc starting stage by stage by the non-consumable electrode welding and the consumable electrode welding comprises:
performing positioning, the arc starting and ignition by a non-consumable electrode welding torch, and controlling the non-consumable electrode torch to move a set distance along a welding direction;
controlling the non-consumable electrode torch to perform arc stopping, and lifting the non-consumable electrode torch; and
controlling a consumable electrode torch to move a zone welded by the non-consumable electrode torch within a set time to control the arc starting stage by stage after the non-consumable electrode torch performs the arc stopping.

16. The all-position multi-layer multi-pass grinding-free welding method for the pipeline according to claim 2, wherein the step S3 further comprises:
cleaning an oxide on a weld bead surface at an arc starting position by an arc force of the non-consumable electrode welding before the arc starting of the filling layer;
the step S4 further comprises:
cleaning the oxide on the weld bead surface at the arc starting position by the arc force of the non-consumable electrode welding before the arc starting of the capping layer.

17. The all-position multi-layer multi-pass grinding-free welding method for the pipeline according to claim 3, wherein the step S3 further comprises:
cleaning an oxide on a weld bead surface at an arc starting position by an arc force of the non-consumable electrode welding before the arc starting of the filling layer;
the step S4 further comprises:
cleaning the oxide on the weld bead surface at the arc starting position by the arc force of the non-consumable electrode welding before the arc starting of the capping layer.
